(19) United States
(12) Patent Application Publication
(10) Pub. No.: US 2017/0196201 A1
(43) Pub. Date: Jul. 13, 2017

(54) Lighting Device for Walking a Pet

(71) Applicant: Ivette Kenney, Pheonix, AZ (US)

(72) Inventor: Ivette Kenney, Pheonix, AZ (US)

(21) Appl. No.: 15/404,047

(22) Filed: Jan. 11, 2017

Related U.S. Application Data
(60) Provisional application No. 62/277,058, filed on Jan. 11, 2016.

(51) Int. Cl. A01K 27/00; H04R 1/02; F21V 23/02; F21V 23/04; F21V 15/01

(52) U.S. Cl. CPC A01K 27/006; A01K 27/009; A01K 27/003; A01K 27/005; F21V 23/0414; F21V 15/01; F21V 23/023; H04R 1/028; F21Y 2115/10

(57) ABSTRACT

An apparatus that can be used as a lighting device when walking a pet consists of a lighting enclosure, a hollow compartment, and a leash. The lighting enclosure is removably attached to the hollow compartment. Therefore, when a body of the hollow compartment is grasped, a lighting switch of the lighting enclosure can be activated to illuminate a light source of the lighting enclosure. The leash is also attached to the lighting enclosure through a hook. Therefore, when the body is grasped the leash can also be controlled as preferred. A handle, which is positioned in parallel to the body can also be used to hold and control the apparatus. To provide storage space for pet waste pick-up bags, an opening of the apparatus traverses through a second end of the hollow compartment and into the body.

The current application claims a priority to the U.S. Provisional Patent application Ser. No. 62/277,058 filed on Jan. 11, 2016.

### FIELD OF THE INVENTION

The present invention relates generally to an accessory used when walking a pet. More specifically, the present invention is a multifunctional dog leash with a built-in lighting system and a siren.

### BACKGROUND OF THE INVENTION

Leashes are used when walking a pet, and can vary in size and shape. Regardless of the shapes and sizes, the functionality and the components of the leash have not changed significantly. A normal leash consists of a handle, a leash body, and a collar hook. The pet owner maintains a firm grip with the use of the handle. The collar hook at the end of the leash body is attached to the collar of the pet.

Traditionally, when a pet owner is walking their pet during a time with low visibility a flashlight or other form of light source is generally used in addition to the leash. This requires the pet owner to handle both the flashlight and the leash simultaneously. Since both the hands need to be used, using a flashlight along with the leash can be a burden to the pet owner.

Pet waste pick-up bags are another commonly carried item when walking a pet. Even though these pet waste pick-up bags are small and lightweight, carrying these pet waste pick-up bags while handling the leash can be stressful to the pet owner.

Both pet owners and pets can be startled by unexpected events during a walk. As an example, the pet owner can feel unsafe in the presence of a stranger. In another instance, a dog can feel unsafe in the presence of another animal. To avoid unfavorable circumstances, a method to overcome such situations such as an alarm is clearly needed.

The objective of the present invention is to address the aforementioned issues. The present invention introduces an apparatus that can be used as a flashlight and as a carrier for pet waste bags. Additionally, the present invention also includes an alarm system that can be used in case of an emergency. By utilizing the present invention, the items that need to be carried when walking a pet are significantly reduced.

### BRIEF DESCRIPTION OF THE DRAWINGS

FIG. 1 is a perspective view of the present invention.

FIG. 2 is a side view of the present invention.

FIG. 3 is an exploded side view of the present invention.

FIG. 4 is a perspective view of the lighting enclosure illustrating the first threaded portion.

FIG. 5 is a perspective view of the hollow compartment and the handle illustrating the opening.

FIG. 6 is a perspective view of the leash.

FIG. 7 is a side view of the leash.

FIG. 8 is a circuit diagram illustrating the electrical connection for the light source.

FIG. 9 a circuit diagram illustrating the electrical connection for the alternative light source.

FIG. 10 a circuit diagram illustrating the electrical connection for the at least one speaker.

FIG. 11 is an illustration of the present invention being used on a pet.

### DETAIL DESCRIPTIONS OF THE INVENTION

All illustrations of the drawings are for the purpose of describing selected versions of the present invention and are not intended to limit the scope of the present invention.

The present invention introduces a lighting device that is integrated into a leash. By utilizing the present invention, the need to carry a flashlight or other comparable device along with the leash is eliminated. Moreover, the present invention can be used for storing items such as pet waste pick-up bags.

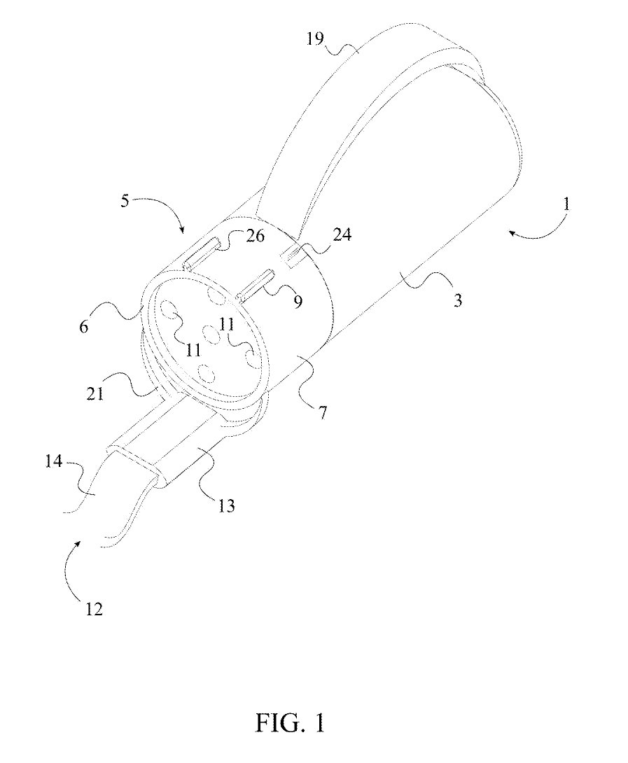

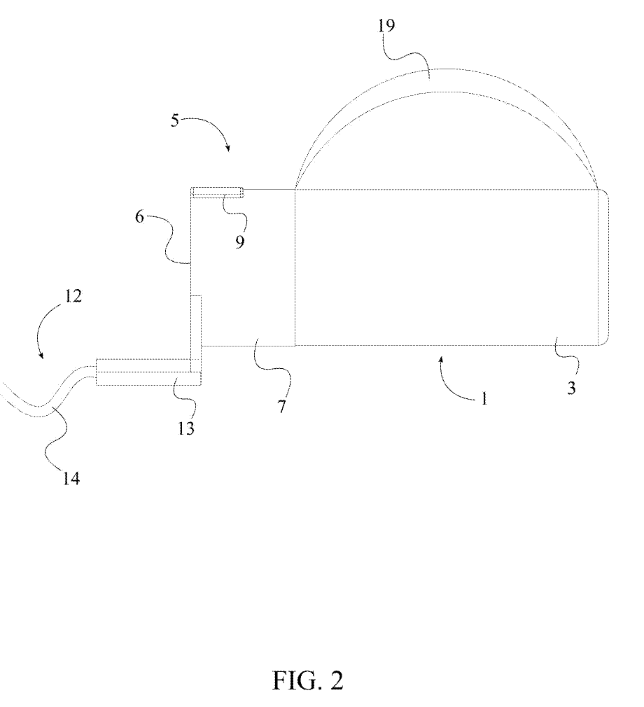

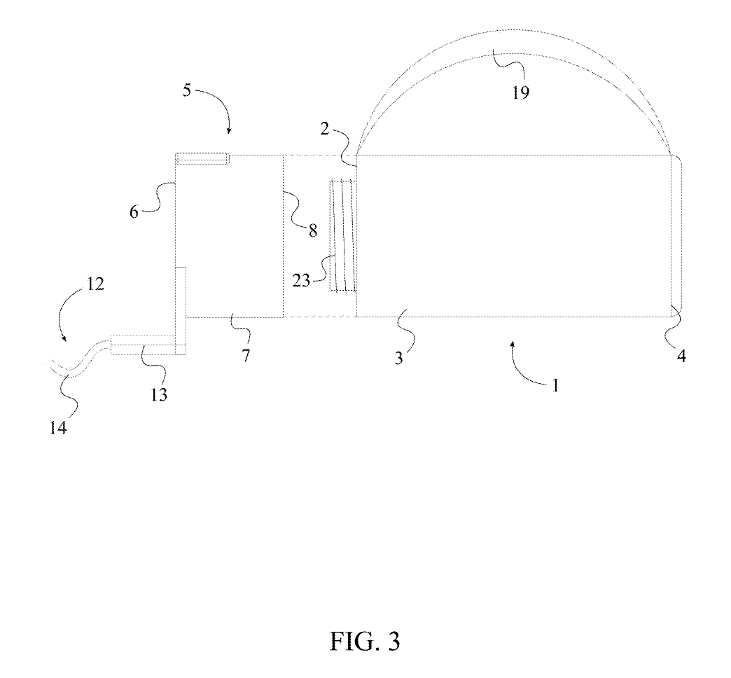

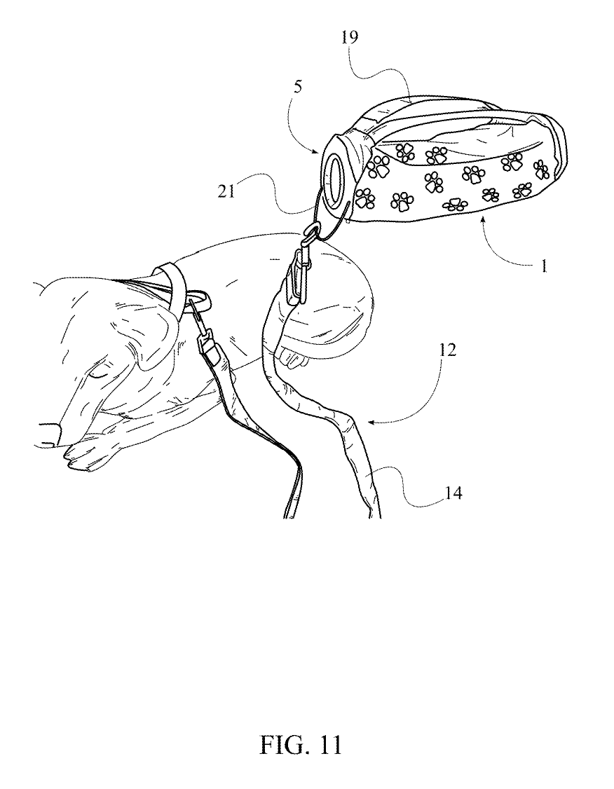

As illustrated in FIG. 1 and FIG. 2, the present invention comprises a hollow compartment 1, a lighting enclosure 5, and a leash 12. The hollow compartment 1 allows the user to carry pet waste pick-up bags or a comparable item of small size. The lighting enclosure 5 consists of the components that are used to provide light when walking the pet. As shown in FIG. 11, the leash 12 is attached to the pet at one end, and connected to the lighting enclosure 5 at the other. As in FIG. 3, since the lighting enclosure 5 is removably attached, the lighting enclosure 5, the hollow compartment 1, and the leash 12 can be controlled simultaneously.

The hollow compartment 1 comprises a first end 2, a body 3, and a second end 4. The body 3 extends from the first end 2 to the second end 4 and determines the length of the body 3. The hollow compartment 1 can vary in size and shape depending on the size and shape of the body 3. As an example, by changing the distance between the first end 2 the second end 4, the length of the hollow compartment 1 can be varied. In the preferred embodiment of the present invention, the body 3 is cylindrical in shape. The cylindrical shape allows the user to maintain a comfortable grip, if the user decides to control the leash 12 by holding the body 3. The shape of the body 3 can vary in different embodiments of the present invention if the functionality of the hollow compartment 1 remains unchanged with the varying shape.

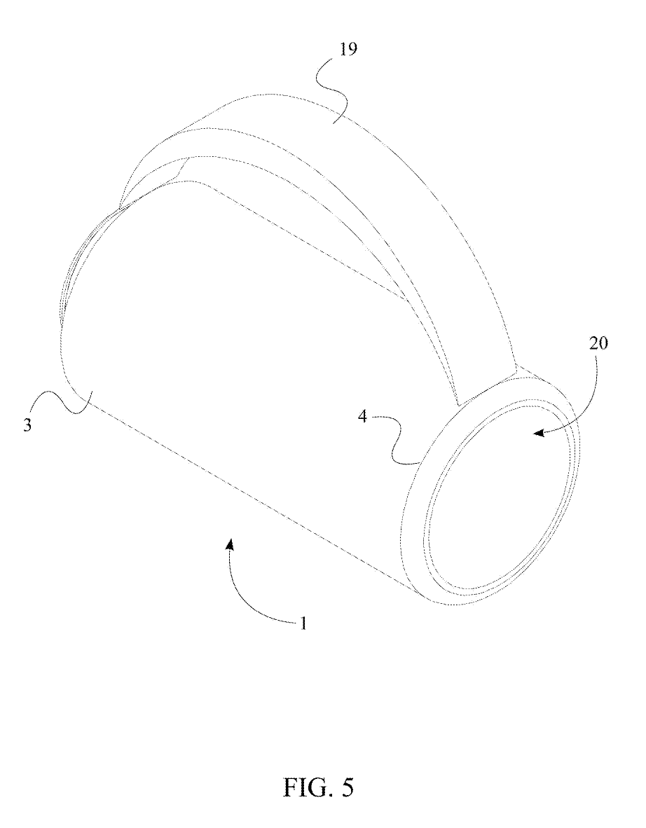

As mentioned earlier, the hollow compartment 1 is used to store pet waste pick-up bags. As seen in FIG. 5, the present invention comprises an opening 20 that traverses through the second end 4 and into the body 3 towards the first end 2. The pet waste pick- up bag is inserted through the opening 20 and positioned within the body 3. Based on the space available within the body 3, even multiple pet waste pick-up bags can be placed within the body 3. Even though the hollow compartment 1 is intended to hold pet waste pick-up bags, other comparable items that are small, such as a key, can also be stored within the body 3. The opening 20 can be concealed with a flap which is connected to the second end 4 with a hook and loop fastener or a zipper.

As seen in FIGS. 1-3, the present invention further comprises a handle 19 which is preferably produced of a material such as fabric neoprene. The handle 19 provides the user with an additional grip to control the leash 12 that is attached to the pet. To do so, the handle 19 is terminally fixed to the hollow compartment 1 at the first end 2 and the second end 4. In the resulting position, the handle 19 is positioned in parallel to the body 3. When the user holds the body 3, the handle 19 acts as a strap that secures the grip of the user.

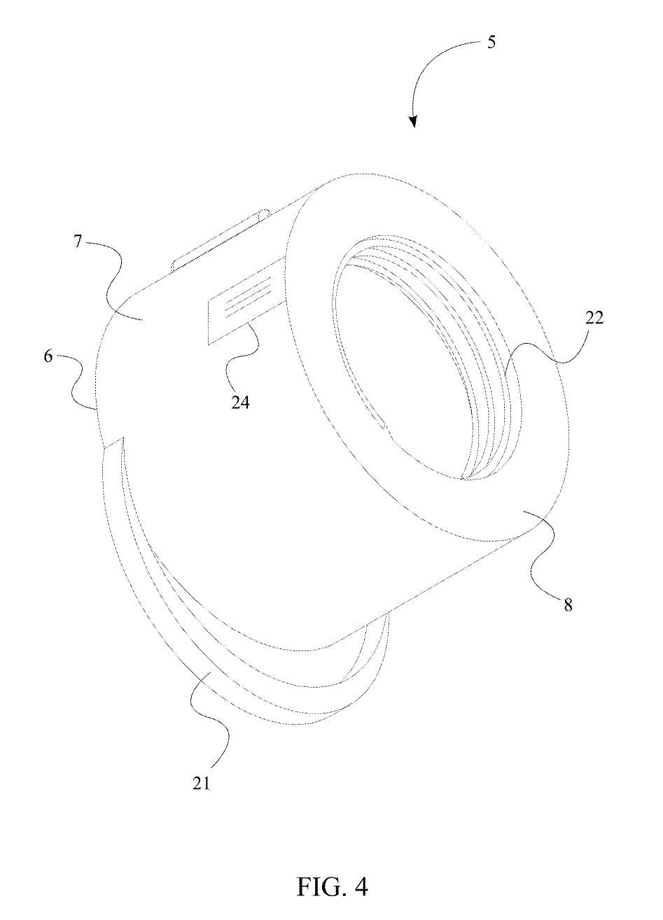

As discussed earlier, the lighting enclosure 5 eliminates the need to carry a flashlight when walking a pet. As illustrated in FIG. 4, the lighting enclosure 5 comprises a first rim 6, a housing 7, and a second rim 8. The housing 7 extends from the first rim 6 to the second rim 8 and can vary in size and shape in different embodiments of the present invention. The lighting enclosure 5 is removably attached to the hollow compartment 1. More specifically, the second rim 8 is removably attached to the hollow compartment 1 at the first end 2. Different attachment mechanisms can be used to removably attach the lighting enclosure 5 to the hollow compartment 1. As seen in FIG. 3 and FIG. 4, in the preferred embodiment, the present invention comprises a first threaded portion 22 and a second threaded portion 23. The first threaded portion 22 is peripherally distributed along the second rim 8. To engage with the first threaded portion 22, the second threaded portion 23 is peripherally distributed along the first end 2 of the hollow compartment 1. When the lighting enclosure 5 is attached to the hollow compartment 1, the first threaded portion 22 is removably engaged with the second threaded portion 23. Preferably, the housing 7 is made of a lightweight material to provide user convenience when utilizing the present invention.

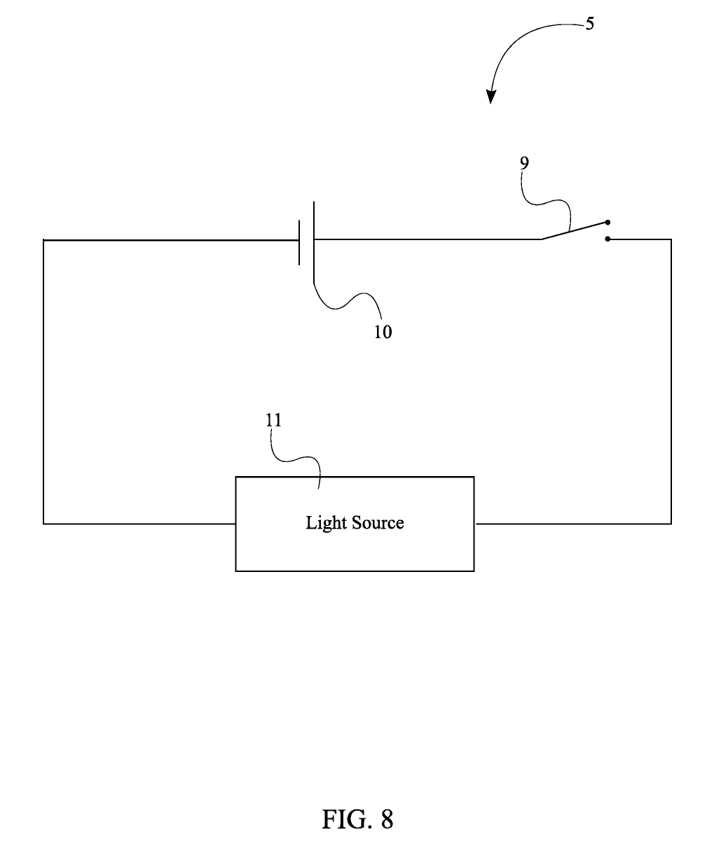

To provide light when utilizing the present invention, the lighting enclosure 5 further comprises a lighting switch 9, a power source 10, and a light source 11. The power source 10 can be, but is not limited to, a battery. Since the lighting enclosure 5 is removably attached, the power source 10 and the light source 11 can be replaced when needed. The light source 11 can vary in different embodiments of the present invention. In the preferred embodiment of the present invention, the light source 11 is a plurality of light emitting diodes (LEDs). Both the power source 10 and the light source 11 are positioned within the housing 7. As shown in FIG. 8, the lighting switch 9, the power source 10, and the light source 11 are electrically connected to each other so that the light source 11 is illuminated through the lighting switch 9. The lighting switch 9 is externally mounted onto the housing 7 so that the user can conveniently utilize the lighting switch 9 when needed. In particular, the lighting switch 9 is positioned such that the user can control the lighting switch 9 while holding the handle 19 or the body 3 of the hollow compartment 1.

The leash 12, which helps the pet owner control the pet, is mounted onto the lighting enclosure 5 adjacent to the first rim 6 so that the leash 12 does not become tangled with the hollow compartment 1. The leash 12 comprises a first end 13, a tether body 14, and a second end 15. The tether body 14, which extends from the first end 13 to the second end 15, determines the length of the leash 12. The length of the tether body 14 can vary in different embodiments of the present invention. In the preferred embodiment, the present invention utilizes a hook 21 when attaching the leash 12 to the lighting enclosure 5. The hook 21 is attached to the first rim 6 so that the first end 13 of the leash 12 is connected to the lighting enclosure 5 with the hook 21. In particular, the hook 21 is pivotally attached to the first rim 6 so that the tether body 14 can move independent of the hollow compartment 1. The second end 15 of the leash 12 is attached to a collar or other comparable attachment point on the pet.

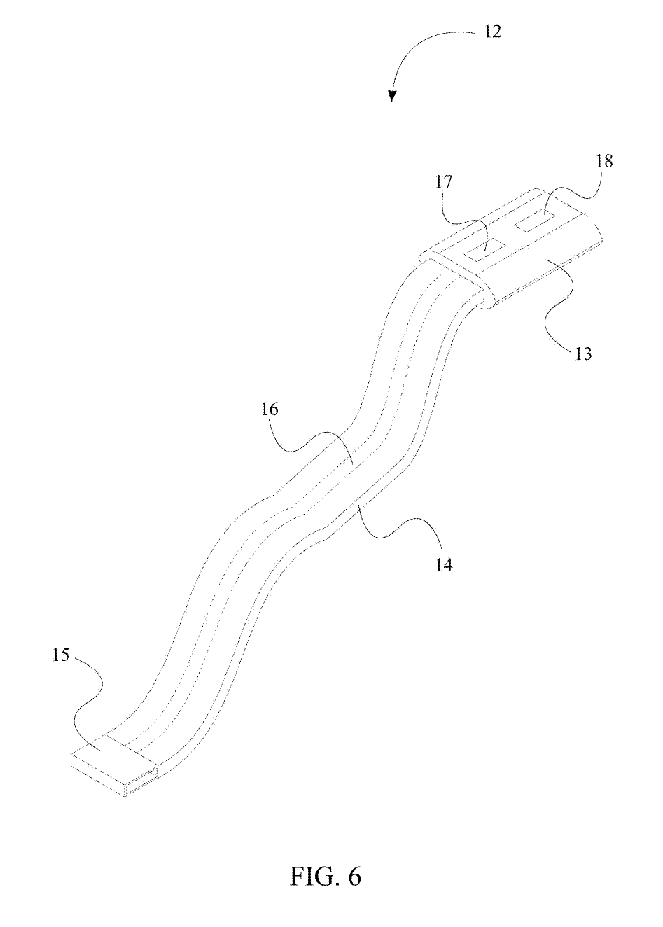

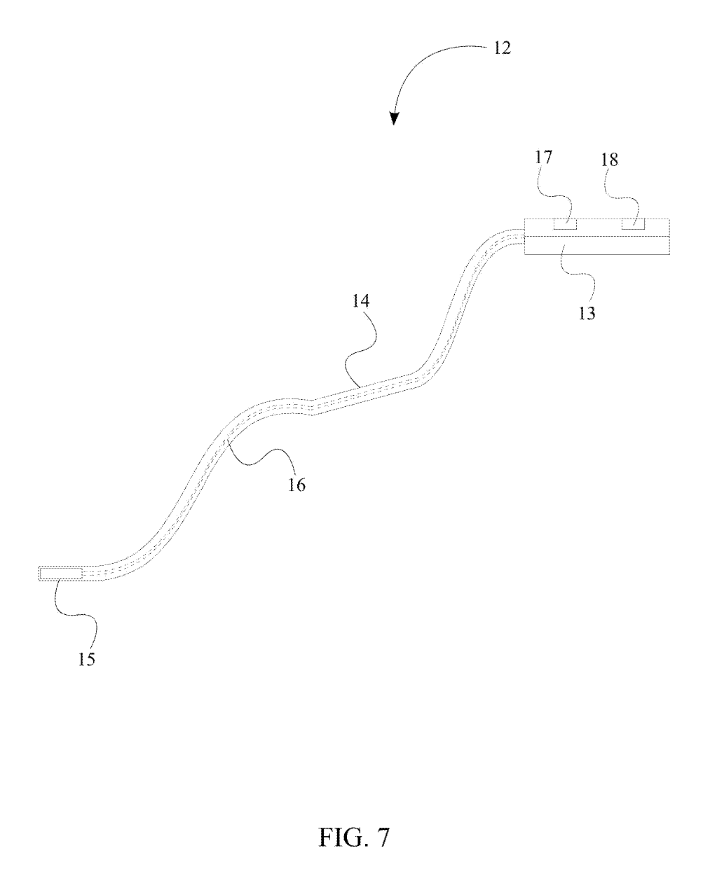

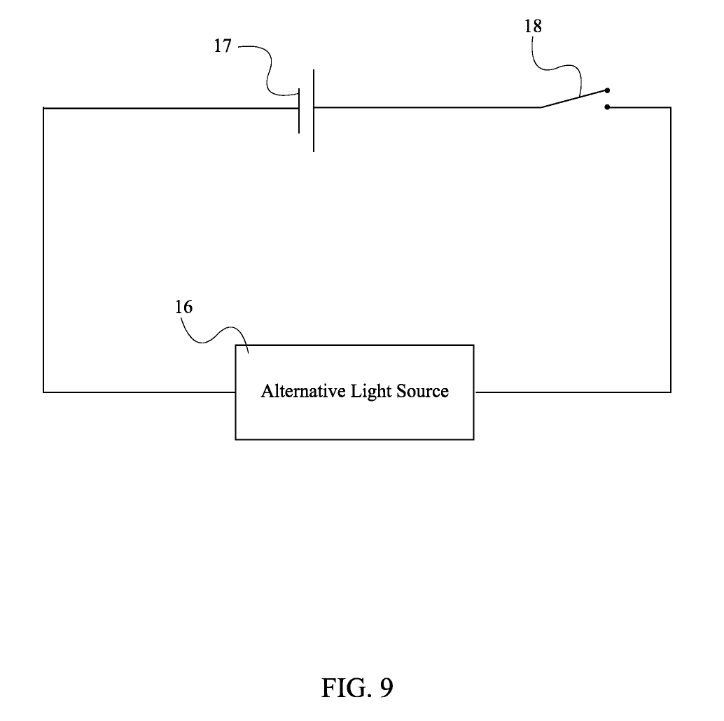

As shown in FIG. 6, FIG. 7, and FIG. 9, the leash 12 further comprises an alternative light source 16, an alternative light switch 18, and an alternative power source 17 which are all electrically connected to each other. The alternative light source 16 and the alternative power source 17 are positioned within the tether body 14. For the illumination of the alternative light source 16 to be visible, the tether body 14 is produced of a transparent material. The alternative light switch 18 is positioned adjacent the first end 13 of the leash 12 or other comparable position. The alternative light source 16 can be, but is not limited to, a plurality of LEDs. Even though the alternative power source 17 is utilized in the preferred embodiment of the present invention, the alternative light source 17 can also be powered through the power source 10 of the lighting enclosure 5. Similarly, the lighting switch 9 of the lighting enclosure 5 can be used to control the alternative light source 16 in another embodiment of the present invention.

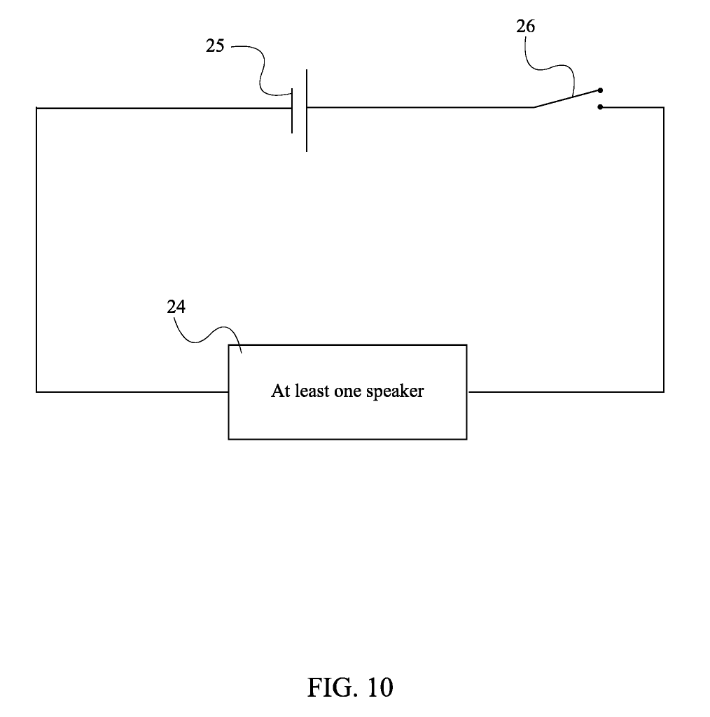

To provide additional protection to the user, the present invention is equipped with an alarm system. As shown in FIG. 10, the alarm system in the preferred embodiment of the present invention comprises of at least one speaker 24, a power source 25, and an audio switch 26 which are all electronically connected to each other. The power source 25, which can be a battery or other comparable power source is positioned within the lighting enclosure 5. To emit sound effectively, the at least one speaker 24 is externally positioned adjacent the housing 7 of the lighting enclosure 5. The audio switch 26, which controls the at least one speaker 24, is externally mounted onto the housing 7. However, the at least one speaker 24 and the audio switch 26 can be positioned differently if the functionality remains unchanged.

When using the present invention, the user grasps the handle 19. If preferred, the body of the hollow compartment 1 can also be used for gripping purposes. When the light source 11 is required, the lighting switch 9 is used. On the other hand, if the alternative light source 16 is needed, the alternative light switch 18 is used. If the user encounters an unexpected situation, the audio switch 26 is pressed so that the at least one speaker 24 outputs an alarm sound. As seen in FIG. 11, the leash 12 is used to control the pet and the hollow compartment 1 is used to store the pet waste pick-up bag or other comparable item.

Although the invention has been explained in relation to its preferred embodiment, it is to be understood that many other possible modifications and variations can be made without departing from the spirit and scope of the invention as hereinafter claimed.

What is claimed is:

1. A lighting device for walking a pet comprises:
a hollow compartment;
a lighting enclosure;
a leash;
the hollow compartment comprises a first end, a body, and a second end;
the lighting enclosure comprises a first rim, a housing, and a second rim;
the body extending from the first end to the second end;
the housing extending from the first rim to the second rim;
the second rim being removably attached to the hollow compartment at the first end; and
the leash being mounted onto the lighting enclosure adjacent to the first rim.

2. The lighting device used for walking a pet as claimed in claim 1 further comprises:
the lighting enclosure further comprises a lighting switch, a power source, and a light source;
the lighting switch, the power source, and the light source being electrically connected to each other;
the lighting switch being externally mounted onto the housing; and
the power source and the light source being positioned within the housing.

3. The lighting device used for walking a pet as claimed in claim 1 further comprises:
a handle; and
the handle being terminally fixed to the hollow compartment at the first end and the second end, wherein the handle is positioned parallel to the body.

4. The lighting device used for walking a pet as claimed in claim 1 further comprises:
an opening; and
the opening traversing through the second end and into the body toward the first end.

5. The lighting device used for walking a pet as claimed in claim 1 further comprises:
the leash comprises a first end, a tether body, and a second end; and
the tether body extending from the first end to the second end.

6. The lighting device used for walking a pet as claimed in claim 5 further comprises:
a hook;
the hook being attached to the first rim; and
the first end of the leash being connected to the lighting enclosure with the hook.

7. The lighting device used for walking a pet as claimed in claim 1 further comprises:
the leash further comprises an alternative light source, an alternative light switch, and an alternative power source;
the alternative light source, the alternative light switch, and alternative power source being electrically connected to each other;
the alternative light source and the alternative power source being positioned within the tether body; and
the alternative light switch being positioned adjacent a first end of the leash.

8. The lighting device used for walking a pet as claimed in claim 1 further comprises:
a first threaded portion;
a second threaded portion;
the first threaded portion being peripherally distributed along the second rim;
the second threaded portion being peripherally distributed along the first end; and
the first threaded portion being removably engaged with the second threaded portion.

9. The lighting device used for walking a pet as claimed in claim 1 further comprises:
at least one speaker;
a power source;
an audio switch;
the at least one speaker, the power source, and the audio switch being electronically connected to each other;
the power source being positioned within the lighting enclosure;
the at least one speaker being externally positioned adjacent the housing; and
the audio switch being externally mounted onto the housing.

10. The lighting device used for walking a pet as claimed in claim 1, wherein the body of the hollow compartment is cylindrical.

11. The lighting device used for walking a pet as claimed in claim 1, wherein the light source is a plurality of light emitting diodes (LEDs).

12. The lighting device used for walking a pet as claimed in claim 7, wherein the alternative light source is a plurality of light emitting diodes (LEDs).
